(19) United States
(12) Patent Application Publication
(10) Pub. No.: US 2017/0067811 A1
(43) Pub. Date: Mar. 9, 2017

(54) DEVICE FOR DETERMINING THE PARTICLE SIZE AND/OR THE PARTICLE SHAPE OF A PARTICLE MIXTURE

(71) Applicant: RETSCH TECHNOLOGY GMBH, Haan (DE)

(72) Inventors: Stephan KNOP, Hagen (DE); Sebastian BEIL, Geilenkirchen (DE)

(21) Appl. No.: 15/122,751

(22) PCT Filed: Feb. 26, 2015
(86) PCT No.: PCT/EP2015/054088

§ 371 Date: Aug. 31, 2016

(30) Foreign Application Priority Data
Mar. 4, 2014 (DE) 20 2014 100 974.4

(51) Int. Cl. G01N 15/02; G01B 11/22; G01B 11/24; G01N 15/14

(52) U.S. Cl. CPC G01N 15/0227; G01N 15/1459; G01N 15/1463; G01B 11/22; G01B 11/24; G01N 2015/1497

(57) ABSTRACT

An apparatus for determining the sizes and/or shapes of particles which are conveyed as a particle flow through a measuring section is disclosed. An illumination device illuminates the particle flow in the measuring section from the rear side. A camera records shadow projections of the particles illuminated by the illumination device from the front side. An analysis unit determines the particle size and/or particle shape via the camera pictures. A projection device is disposed on the front side of the measuring section and positioned at an angle α to the camera in order to project a light line onto the particles of the particle flow in the measuring section. The light line is recorded by the camera, depth information and/or geometric information on the recorded particles being determined from the shape of the light line in the analysis unit.

### CROSS-REFERENCE TO RELATED APPLICATIONS AND CLAIMS TO PRIORITY

This application is a national stage application of International Application No. PCT/EP2015/054088 filed Feb. 26, 2015, which claims priority to German Patent Application No. 202014100974.4 filed Mar. 4, 2014, the disclosures of which are incorporated herein by reference and to which priority is claimed.

### FIELD OF THE INVENTION

The present invention relates to an apparatus for determining the particle sizes and/or the particle shapes of particles of a particle mixture that comprises a delivery device which isolates the particles of the particle mixture and then conveys them as a particle flow through a measuring section, an illumination device which is disposed on one side—the rear side—of the measuring section and is directed at the measuring section in order to illuminate the particle flow in the measuring section from the rear side, a camera which is positioned on the front side of the measuring section lying opposite the illumination device and is directed at the measuring section in order to record shadow projections of the particles illuminated by the illumination device, and an analysis unit that determines the particle size and/or particle shape of the recorded particles by means of the camera pictures. Furthermore, the invention relates to a method for determining the particle size and/or the particle shapes of particles of a particle mixture, wherein the particles of the particle mixture are isolated and are then conveyed through a measuring section as a particle flow, the particle flow being illuminated from the rear side of the measuring section by means of an illumination device, shadow projections of the illuminated particles being recorded by a camera from the front side of the measuring section and the particle size and/or particle shape of the recorded particles being determined by means of the camera pictures.

### BACKGROUND OF THE INVENTION

The analysis of the particle shape and size of bulk materials with the aid of digital image processing is a widely used method. A basic distinction is made here between static and dynamic analysis methods. Apparatuses for determining the particle sizes and/or the particle shapes of particles of a particle mixture which are based upon dynamic image processing are known, for example, from DE 198 02 141 C1, EP 0 348 469 B1, DE 10 2004 031 052 A1 and EP 2 330 400 A2. These known apparatuses comprise a delivery device with a funnel-shaped storage container for particulate bulk material and a vibrating plate which serves to isolate particles delivered from the storage container so that they fall from the vibrating plate through a measuring section as a curtain-like particle flow. Assigned to the measuring section is an illumination device which is disposed on the rear side of the measuring section and is directed at the measuring section in order to illuminate the particle flow two-dimensionally in the measuring section from the rear side. Furthermore, a camera is provided which is positioned on the front side of the measuring section lying opposite the illumination device and is directed at the measuring section in order to record shadow projections of the particles illuminated by the illumination device. With appropriate analysis programmes dimensions and shape parameters can be determined from the shadow projection of each individual particle. Shadow projections are generally well suited to determine the outlines of a particle. It is easy to binarise the recorded data because in the ideal case only two events have to be taken into account, namely light and dark. However, one only obtains limited information on the contour of the surface because the front side of the recorded particles facing the camera appears as a continuously black area. A similar apparatus wherein the particles are illuminated by an illumination device positioned laterally with respect to the recording direction of the camera is disclosed by JP 60015541 A.

The advantage of the dynamic methods is the measurement of a large sample quantity in a relatively short time. This results in high statistical reliability of the measurements. A disadvantage of this method is that generally only a two-dimensional projection of a random orientation of each particle is detected. Since the results of the dynamic methods are mostly compared with data from screenings, one demands the best possible correlation between screening and dynamic image processing. When determining size by screening the screen mesh width of the screens used is decisive for the so-called size category into which a particle is sorted. A particle can only pass through a screen mesh if its smallest projection surface is smaller than the screen mesh. Since in dynamic image processing only a random orientation of a particle is recorded, it inevitably follows that the smallest projection surface can also vary greatly. The uncertainty increases the further the shape of the particles deviates from that of a sphere. Generally, therefore, the size distribution of asymmetrical particles that can be determined with the aid of dynamic image processing is broader that that obtained with the aid of screening. It is nevertheless possible, however, to establish a correlation between the two measuring methods for specific samples by analysis routines and corrections. However, this is associated with a considerable degree of complexity. Hence the endeavours to obtain three-dimensional data on the particles to be measured. For example, it is proposed in U.S. Pat. No. 8,270,668 B2 to record one and the same particle a number of times from different viewing directions. In doing so the self-rotation of the falling particles is utilised by recording images of the particle at different times during the free fall.

Apart from that, there are apparatuses and methods for three-dimensionally measuring large objects using light line projections in order to obtain three-dimensional geometric information about the measured objects. Apparatuses and methods of that type are, for example, disclosed by DE 10 2012 101 302 A1, U.S. Pat. No. 4,541,722, US 2003/0160974 or US 2002/0196415 A1.

Static image processing methods have a high spatial resolution and can be operated with both incident light and transmitted light. However, the sample volume observed is small. In addition, the particles being examined are in a preferred orientation due to them being placed on an object carrier. Therefore, no statically distributed orientation of the individual particles is observed. One can overcome this disadvantage by certain optical systems such as for example confocal microscopy. However, static image processing remains associated with the problem that only small sample volumes can be analysed.

### SUMMARY OF THE INVENTION

Therefore, the object of the following invention is to design an apparatus and a method for determining the particle sizes and/or the particle shapes of particles of a particle mixture of the type specified initially which work according to the principle of dynamic image processing so that additional data regarding the geometry of the particles to be measured are easily obtained.

This object is achieved with an apparatus of the type specified initially by there being assigned to the camera a projection device which is disposed on the front side of the measuring section, is directed at the measuring section and is positioned at a triangulation angle α to the camera in order to project a light line onto the particles of the particle flow in the measuring section which is also recorded by the camera, depth information and/or geometric information on the recorded particles being determined from the shape of the light line in the analysis unit.

Furthermore, the object is achieved by a method of the type specified initially by projecting a light line from the front side of the measuring section onto the particles of the particle flow in the measuring section by a projection device and recording the light line by the camera, depth information and/or geometric information on the recorded particles being determined from the shape of the light line.

Therefore, the invention is based on the idea of using the light section method, also called line triangulation, to determine the surface profile of the particles. For this purpose a narrow light line is projected through a projection device onto the front side of the particles to be measured. The projection device is accordingly disposed on the front side of the measuring section, but positioned with an angular offset to the camera so that the projection axis of the projection device to the optical axis of the camera is offset by a triangulation angle α. The particle flow is generally conveyed in a direction Y in a straight line—for example in free fall—through the measuring section. Advantageously the projection device and the camera are then arranged so that the projection axis of the projection device and the optical axis of the camera lie in an X, Z plane perpendicular (horizontal) to the direction of movement Y of the particles and in this plane are arranged offset to one another by the triangulation angle α. During operation the particle flow in the region of the measuring section is illuminated two-dimensionally from its rear side in order to generate a shadow projection that is recorded by the camera from the front side of the measuring section. In addition, in a narrow region of the camera's field of vision a thin light line is projected onto the particles with the aid of the projection device. This light line is partially scattered back by the falling particles, and the scattered light is detected by the camera. Depth information as well as geometric information on the measured particles can then be obtained from the shape of the light line with appropriate analysis software. Together with the contour information which is obtained in the known manner from the shadow projection one can calculate a full reconstruction of the side of the measured particles facing the camera if there is a sufficiently high frame rate of the camera. By means of the movement of the particles relative to the generated light line and the camera complete scanning in the direction of movement Y of the particles is achieved.

In order to achieve complete scanning of the particles a very high frame rate of the camera(s) used is required. So that particles only move a few pixels between two consecutive images, frame rates of more than 1000 images/second must be made possible. In order to achieve this frame rate many cameras have the option of only reading out certain regions of a camera chip. Likewise, one can use cameras the CCD or CMOS chips of which have (optionally) logarithmic sensitivity in order to compensate for differences in the scattering behaviour caused by the heterogeneity of the bulk material that is to be analysed.

According to a preferred embodiment of the invention provision is made such that a camera and a projection device assigned to the camera are provided on the rear side of the measuring section in order to generate and to record a light line on the rear side of the particles, depth information and/or geometric information on the recorded particles being determined in the analysis unit from the shape of the light line. In this embodiment an additional projection device and an additional camera are disposed on the rear side of the measuring section so as to also generate and to record a light line on the rear side of the particles in the measuring section and obtain contour information on the rear side of the particles from the shape of the light line. Accordingly, the camera and the projection device are arranged offset to one another by a triangulation angle α on the rear side of the measuring section and preferably in a (horizontal) plane X, Z that is perpendicular to the direction of movement Y of the particles to be detected. Advantageously the arrangement is made so that the projection axes of the two projection devices and the optical axes of the cameras on the front and the rear side of the measuring section all lie in a common X, Z plane.

The illumination device and the projection device on the rear side of the measuring section are advantageously pulsed or clocked so that they are alternately active and the particles are illuminated either by the illumination device or by the projection device. In other words, the particles are not illuminated by the illumination device when the projection line is generated so that the light line can be detected well by the camera on the rear side of the measuring section.

Suitable projection devices for generating a thin light line on the front side and/or on the rear side of the measuring section preferably comprise a laser and/or at least one LED as a light source. In addition, lenses and/or diffractive optical elements are preferably used to generate the light line.

Furthermore, the projection devices on the front side and/or on the rear side of the measuring section are configured to generate projection lines of different colours. It is known that different materials have different absorption and transmission properties. This has a direct effect upon the amount of light that is scattered back. It is therefore advantageous to have available a plurality of possible projection colours that can be used optionally depending on the material of the particle mixture to be measured in order to generate a light line.

According to one embodiment of the invention provision is made such that a filter device is provided upstream of the camera on the front side and/or on the rear side of the measuring section in order to filter out light produced by fluorescence excitation on the surface of the particles to be analysed. For example, the filter means can comprise a high pass and/or a band pass filter.

Alternatively or in addition the filter device can also comprise filters for discriminating predetermined polarisation directions of the light scattered by the particles in the measuring section, and this can be particularly advantageous when measuring transparent particles.

In a further development of the invention provision is made such that the analysis unit is configured to further process the images of the light lines that are generated by the projection device on the front side and/or on the rear side of the measuring section by appropriate software filters and/or adaptation algorithms, in particular by sub-pixeling and/or Gaussian adaptation, so that the highest possible resolution of the light lines is achieved. This embodiment results in a high degree of accuracy of the depth and topography information that is obtained.

Furthermore, it is advantageous for the algorithmic determination of the light line to define a region of interest (ROI) within each recorded image. This considerably reduces the search effort for the analysis programme. In order to determine such regions it is helpful to track particles by means of the shadow projections recorded by the camera by consecutive images being accordingly analysed. In this way one can predict when the tracked particles will pass into the region of the light line and define corresponding ROIs in subsequently recorded images in which the light line is analysed.

In a manner known in its own right the delivery device is configured to isolate a particle mixture above the measuring section and to generate a particle flow in the form of a particle curtain that moves through the measuring section in free fall. Rotation of the falling particles relative to the falling plane is not desirable here. For this reason the delivery device preferably has means such as for example guiding plates for counteracting rotation of the falling particles relative to the falling plane.

### BRIEF DESCRIPTION OF THE DRAWINGS

With regard to further advantageous embodiments reference is made to the following description of an exemplary embodiment with reference to the attached drawings. The drawings show as follows:

FIG. 1 a schematic illustration of an apparatus for determining the particle sizes and/or the particle shapes of particles of a particle mixture according to the present invention, and

FIG. 2 a shadow projection of a particle with a projected light line that is obtained by using the apparatus according to the invention.

### DETAILED DESCRIPTION OF THE PREFERRED EMBODIMENT(S)

FIG. 1 shows the schematic illustration of an apparatus for determining the particle sizes and/or the particle shapes of particles of a particle mixture according to the present invention. The apparatus comprises a delivery device 1 with a funnel-shaped storage container 2 for particulate bulk materials and a conveying device in the form of a vibrating plate 3 positioned beneath the outlet opening of the storage container 2, which vibrating plate serves to catch particles T falling out of the storage container 2 and to transport them along the vibrating plate 3 to the free output end of the vibrating plate 3 where they fall from the vibrating plate 3. In this way a curtain-like particle flow of particles T moving in the vertical direction Y is generated in a falling plane E. During the fall rotation of the particles T is not desirable. For this reason the delivery device 1 has means (not shown) such as for example guide plates, counteracting rotation of the particles T or prevent rotation. Provided beneath the delivery device 1 is a catching container (not shown) in which the particle flow is collected.

Part of the falling section is defined as a measuring section M. Assigned to this measuring section M is an illumination device 4 of the apparatus which is disposed on the rear side of the measuring section M and is directed at the measuring section M in order to illuminate the particle flow two-dimensionally in the measuring section M from the rear side. Furthermore, this apparatus comprises a camera 5 which is positioned on the front side of the measuring section M lying opposite the illumination device 4 and is directed at the measuring section M in order to record shadow projections of the particles T illuminated by the illumination device 4. Finally, the apparatus comprises a projection device 6 assigned to the camera 5 which is disposed on the front side of the measuring section M and is also directed at the measuring section M. The projection device 6 serves to project a thin light line L onto the particles T in the measuring section M, which light line is also recorded by the camera 5. For this purpose the projection device 6 is positioned with an angle offset to the camera 5 so that the projection axis P of the projection device 6 encloses a triangulation angle α with the optical axis K of the camera 5. Specifically, the projection device 6 and the camera 5 are arranged so that the projection axis P of the projection device 6 and the optical axis K of the camera 5 lie in an X, Z plane perpendicular, i.e. horizontal, to the direction Y of movement or the falling plane E of the particles T and are arranged offset to one another by triangulation angle α in this plane.

In order to generate the thin light line L the projection device 6 comprises a laser or an LED as a light source. In addition, the projection device 6 includes lenses and/or diffractive optical elements for generating the light line L. Furthermore, the projection device 6 is configured to generate differently coloured projection lines. It is known that different materials have different absorption and transmission properties. This has a direct effect upon the amount of light that is scattered back. It is therefore advantageous to have available a plurality of possible projection colours which can be used optionally depending on the material of the particle mixture to be measured in order to generate the light line L.

Finally, the apparatus according to the invention comprises an analysis unit 7 that is coupled to the camera 5 in order to analyse the images recorded by the camera 5. For this purpose the analysis unit 7 is provided with corresponding analysis software that makes it possible to analyse the recorded shadow projection and the recorded light line L in order to obtain information relating to the particle sizes and/or the particle shapes of the particles recorded by the camera 5.

For this purpose the analysis device 7 is configured to further process the images of the light lines L generated by the projection device 6 by means of appropriate software filters and/or adaptation algorithms, in particular by means of sub-pixeling and/or Gaussian adaptation, so that monopixel resolution of the light lines is achieved. This embodiment results in a high degree of accuracy.

Finally, the analysis unit 7 for the algorithmic determination of the light line defines a region of interest (ROI) within each recorded image. This considerably reduces the search effort for the analysis programme. Specifically, the analysis unit 7 analyses consecutive images of the camera 5 in order to track shadow projections of individual particles on the basis of consecutive images. In this way it can be predicted when the corresponding particles will enter into the region of the generated light line so that corresponding ROIs can be defined in subsequently recorded images.

During operation the particles to be examined are conveyed via the vibrating plate 3 in the direction of the falling plane E and are thereby isolated. As soon as a particle T reaches the output end of the vibrating plate 3 that is on the right in the drawing it passes into free fall. The illumination device 4 illuminates the particles from the rear side of the measuring section M and thus generates a shadow projection that is recorded by the camera 5 on the front side of the measuring section M.

In addition, a thin light line L is projected into a narrow region of the camera's field of vision with the aid of the projection device 6. This light line L is partially scattered back by the falling particles T and the scattered light is also detected by the camera 5. From the contour information which is obtained from the shadow projection and from the additional information which is obtained from the shape of the light line a full reconstruction of the side of the recorded particles T facing the camera 5 can then be calculated in the analysis unit by means of appropriate analysis software in the analysis unit. Full scanning in the Y direction is achieved here by the movement of the particles T relative to the light line L and the camera 5.

In order to achieve full scanning of the particles a very high frame rate of the camera 5 used is necessary. So that particles between two consecutive images only move a few pixels, frame rates of more than 1000 images/second must be made possible. In order to achieve this frame rate many cameras have the option of only reading out certain regions of a camera chip. Likewise, cameras can be used the CCD or CMOS chips of which have (optionally) logarithmic sensitivity in order to compensate for differences in the scattering behaviour which occur due to the heterogeneity of the bulk material to be analysed.

Furthermore, in a manner that is not illustrated there is assigned to the camera 5 a filter device for filtering out light that has been produced on the surface of the particles to be analysed by fluorescence excitation. For example, the filter means can have a high pass and/or a band pass filter.

Likewise, the filter device can have filters for discriminating predetermined polarisation directions of the light scattered by the particles in the measuring section, and this can be advantageous, in particular when measuring transparent particles.

FIG. 2 shows a diagrammatic illustration of a shadow projection of a falling particle with a projected light line L. The particle is a cylindrical body. The drawing shows that only the external outline can be determined by the shadow projection. It can be clearly seen from FIG. 2 that additional shape information on the particle T can be obtained by the projected light line. The generation of a light line L offers further advantages in addition to the three-dimensional measurement of the particles. In a case where a particle T does not move precisely in the falling plane E, as shown in FIG. 1, perspective errors occur when recording shadow projections. If the trajectory of particle T lies closer to the camera 5 (smaller Z values), the particle T seems to be larger for the camera 5; if however the trajectory of the particle T is further away from the camera 5 (greater Z values), it seems smaller for the camera 5. Determination of the precise Z position of the particle T is possible with the aid of the projected light line L. Thus, by using linear optics, the perspective error of the shadow projection can be compensated.

1-24. (canceled)

25. An apparatus for determining the particle sizes and/or the particle shapes of particles (T) of a particle mixture comprising a delivery device (1) which isolates the particles (T) of the particle mixture and then conveys them as a particle flow through a measuring section (M), an illumination device (4) which is disposed on one side—the rear side—of the measuring section (M) and is directed at the measuring section (M) in order to illuminate the particle flow in the measuring section (M) from the rear side, a camera (5) which is positioned on the front side of the measuring section (M) lying opposite the illumination device (4) and is directed at the measuring section (M) in order to record shadow projections of the particles (T) illuminated by the illumination device (4), and an analysis unit (7) that determines the particle size and/or particle shape of the recorded particles (T) by means of the camera (5) pictures, wherein there is assigned to the camera (5) a projection device (6) which is disposed on the front side of the measuring section (M), is directed at the measuring section (M) and is positioned at a triangulation angle α to the camera (5) in order to project a light line (L) onto the particles (T) of the particle flow in the measuring section (M), which light line is also recorded by the camera (5), depth information and/or geometric information on the recorded particles (T) being determined from the shape of the light line (L) in the analysis unit (7).

26. The apparatus according to claim 25, wherein a camera and a projection device assigned to the camera are provided on the rear side of the measuring section (M) in order to generate and to record a light line on the rear side of the particles (T), depth information and/or geometric information on the recorded particles (T) being determined in the analysis unit (7) from the shape of the light line, wherein particularly the illumination device (4) and the projection device on the rear side of the measuring section (M) are pulsed or clocked so that they are alternately active.

27. The apparatus according to claim 25, wherein the projection device (6) on the front side of the measuring section (M) has a laser and/or at least one LED as a light source and/or that the projection device (6) on the front side of the measuring section (M) has a light source and additionally lenses and/or diffractive optical elements in order to generate the light line wherein particularly the projection device (6) on the front side of the measuring section (M) is configured to generate projection lines of different colours.

28. The apparatus according to claim 27, wherein the filter device comprises filters for discriminating predetermined polarisation directions of the light scattered by the particles (T) in the measuring section (M).

29. The apparatus according claim 27, wherein a filter device is provided upstream of the camera (5) on the front side of the measuring section (M) in order to filter out light produced by fluorescence excitation on the surface of the particles (T) to be analysed, wherein the filter materials comprise a high pass and/or a band pass filter.

30. The apparatus according to claim 29, wherein the filter device comprises filters for discriminating predetermined polarisation directions of the light scattered by the particles (T) in the measuring section (M).

31. The apparatus according to claim 25, wherein the analysis unit (7) is configured to further process the images of the light lines that are generated by the projection device (6) on the front side of the measuring section (M) by appropriate software filters and/or adaptation algorithms, in particular by subpixeling and/or Gaussian adaptation so that the highest possible resolution of the light lines is achieved, wherein particularly the analysis unit (7) is configured to track individual particles (T) by means of the shadow projections recorded by the camera (5) and to calculate when tracked particles (T) will pass into the region of the generated light line (L), the analysis unit (7) then defining within subsequently recorded images corresponding regions of interest that are used for the algorithmic determination of the light line (L).

32. The apparatus according to claim 25, wherein the particle flow is conveyed in a direction (Y) in a straight line or substantially in a straight line through the measuring section (M), and that the camera (5) and the assigned projection device (6) are disposed on the front side and/or on the rear side of the measuring section (M) in a plane (X, Z) perpendicular to the direction (Y) of movement of the particles (T), wherein particularly the delivery device (1) is configured to isolate a particle mixture above the measuring section (M) and to generate a particle flow in the form of a particle curtain that moves in free fall through the measuring section (M) and the delivery device (1) is configured to prevent rotation of the falling particles (T) relative to the falling plane.

33. The apparatus according to claim 29, wherein the particle flow is conveyed in a direction (Y) in a straight line or substantially in a straight line through the measuring section (M), and that the camera (5) and the assigned projection device (6) are disposed on the front side and/or on the rear side of the measuring section (M) in a plane (X, Z) perpendicular to the direction (Y) of movement of the particles (T), wherein particularly the delivery device (1) is configured to isolate a particle mixture above the measuring section (M) and to generate a particle flow in the form of a particle curtain that moves in free fall through the measuring section (M) and the delivery device (1) is configured to prevent rotation of the falling particles (T) relative to the falling plane.

34. The apparatus according to claim 31, wherein the particle flow is conveyed in a direction (Y) in a straight line or substantially in a straight line through the measuring section (M), and that the camera (5) and the assigned projection device (6) are disposed on the front side and/or on the rear side of the measuring section (M) in a plane (X, Z) perpendicular to the direction (Y) of movement of the particles (T), wherein particularly the delivery device (1) is configured to isolate a particle mixture above the measuring section (M) and to generate a particle flow in the form of a particle curtain that moves in free fall through the measuring section (M) and the delivery device (1) is configured to prevent rotation of the falling particles (T) relative to the falling plane.

35. A method of determining the particle size and/or the particle shapes of particles (T) of a particle mixture wherein
the particles (T) of the particle mixture are isolated and then conveyed through a measuring section (M) as a particle flow,
the particle flow is illuminated from one side—the rear side—of the measuring section (M) by means of an illumination device (4),
shadow projections of the illuminated particles (T) are recorded by a camera (5) from the front side of the measuring section (M) opposite to the illumination device (4), and
the particle size and/or the particle shape of the recorded particles (T) are determined by means of the camera (5) pictures, wherein a light line (L) is projected by a projection device (6) from the front side of the measuring section (M) onto the particles (T) of the particle flow in the measuring section (M) and the light line (L) is recorded by the camera (5) positioned at a triangulation angle α to the camera (5), depth information and/or geometric information on the recorded particles (T) being determined from the shape of the light line (L).

36. The method according to claim 35, wherein a light line is projected by a projection device from the rear side of the measuring section (M) onto the particles (T) of the particle flow in the measuring section (M) and the light line is recorded by a camera disposed on the rear side of the measuring section (M), depth information and/or geometric information on the recorded particles (T) being determined from the shape of the light line, wherein particularly the illumination device (4) and the projection device on the rear side of the measuring section (M) are pulsed or clocked so that they are alternately active.

37. The method according claim 36, wherein light produced by fluorescence excitation on the surface of the particles (T) in the particle flow is filtered out.

38. The method according claim 36, wherein predetermined polarisation directions of the light scattered by the particles (T) is discriminated.

39. The method according claim 37, wherein predetermined polarisation directions of the light scattered by the particles (T) is discriminated.

40. The method according to claim 35, wherein the images of the light lines that are generated on the particles (T) on the front side of the measuring section (M) are further processed by appropriate software filters and/or adaptation algorithms, in particular by subpixeling and/or Gaussian adaptation so that that the highest possible resolution of the light lines is achieved.

41. The method according to claim 35, wherein individual particles (T) are tracked by means of the shadow projections recorded by the camera (5) and it is calculated when tracked particles (T) will pass into the region of the generated light line, corresponding regions of interest then being defined within subsequently recorded images, which regions of interest are used for the algorithmic determination of the light line.

42. The method according to any of claim 35, wherein the particle flow is conveyed in a direction (Y) in a straight line or substantially in a straight line through the measuring section (M), and that the camera (5) and the assigned projection device (6) are disposed on the front side of the measuring section (M) in a plane (X, Z) perpendicular to the direction (Y) of movement of the particles (T).

43. The method according to any of claim 35, wherein the particle mixture is isolated above the measuring section (M) and a particle flow in the form of a particle curtain is generated that moves in free fall through the measuring section (M) and/or that rotation of the falling particles (T) relative to the falling plane is prevented.

44. The method according to any of claim 42, wherein the particle mixture is isolated above the measuring section (M) and a particle flow in the form of a particle curtain is generated that moves in free fall through the measuring section (M) and/or that rotation of the falling particles (T) relative to the falling plane is prevented.
